(19) United States
(12) Patent Application Publication
(10) Pub. No.: US 2007/0176862 A1
(43) Pub. Date: Aug. 2, 2007

(54) Active matrix display with pixel to pixel non-uniformity improvement at low luminance level

(75) Inventors: Ralph Kurt, Eindhoven (NL); Ingrid Maria Laurentia Cornelis Vogels, Eindhoven (NL); David Andrew Fish, Haywards Heath (GB); Ingrid Emilienne Joanna Rita Heynderickx, Eindhoven (NL); Nijs Cornelis Van DerVaart, Eindhoven (NL); Andrea Giraldo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,880

(22) PCT Filed: Mar. 8, 2005
(86) PCT No.: PCT/IB05/50842

§ 371 Date: Sep. 14, 2006

(30) Foreign Application Priority Data
Mar. 19, 2004 (EP) 04251578.3

(51) Int. Cl. G09G 3/32

(52) U.S. Cl. 345/82

(57) ABSTRACT

An active matrix display (1) comprises a pixel (P) including sub-pixels (10), and a drive circuit (6) which receives an input signal (IV) determining a desired luminance (BR) and a desired color (AC) of the pixel (P). The drive circuit (6) comprises a level detector (3) which determines whether the desired luminance (BR) is below a predetermined level (VT), and a controller (4) for, when the desired luminance (BR) is below the predetermined level (VT), (i) changing a number of the sub-pixels (10) contributing to the desired luminance (BR) into a lower number than optimally required to obtain the desired color (AC), and (ii) increasing a level of at least one of said contributing sub-pixels (10) to obtain a higher luminance of this one of said contributing sub-pixels (10) than if all the sub-pixels (10) required to obtain the desired color (AC) would contribute to the desired luminance (BR):

### FIELD OF THE INVENTION

The invention relates to an active matrix display and a method of displaying an image on an active matrix display.

### BACKGROUND OF THE INVENTION

JP-A-11-015437 discloses a LED display device which corrects differences of luminance characteristics between the LED elements by performing luminance corrections to the display data of the red, green, and blue LED elements. A luminance correction factor has to be stored for each LED element.

### SUMMARY OF THE INVENTION

It is an object of the invention to provide an active matrix display in which the pixel to pixel non-uniformity at low luminance levels is improved without requiring storing a correction factor for each LED element.

A first aspect of the invention provides an active matrix display as claimed in claim 1. A second aspect of the invention provides a method of displaying an image on an active matrix display as claimed in claim 10. Advantageous embodiments are defined in the dependent claims.

The active matrix display comprises a pixel comprising sub-pixels. The sub-pixels each are driven to generate a desired amount of light which contributes to the luminance of the pixel. Usually, different sub-pixels of a pixel have different colors. For example, in a full color display, the pixel may comprise three sub-pixels which generate blue, red and green light, respectively. Alternatively, the pixel may comprise four sub-pixels which generate blue, red, green and white light. It is also possible to replace the red, green, blue sub-pixels by yellow, cyan and magenta pixels or to add the yellow, cyan and magenta pixels.

A drive circuit receives an input signal which determines a desired luminance and a desired color of the pixel. More in detail, the drive circuit drives the sub-pixels of the pixel such that the desired luminance and color of the pixel is obtained by the combination of the light emitted by the sub-pixels. The drive of the sub-pixels depends on the number and type of sub-pixels used.

It is determined whether a desired luminance of the pixel is below a predetermined level. Usually, the luminance of the pixel can be calculated from the video input signal which has to be displayed. This video input signal may be a composite signal, a YUV signal or a RGB signal. If the video input signal is a YUV signal (Y=luminance, U and V represent the color information), the luminance signal may be used. If the video input signal is an RGB signal (Red, Green, Blue), the R, G and B components may be summed using appropriate weighting factors to obtain the corresponding luminance value. It is also possible to use the drive signals of the sub-pixels to determine the luminance of the pixel. If the desired luminance of a pixel is below the predetermined level, the drive circuit is controlled to drive only a subset of the sub-pixels required to obtain the desired color of this pixel. Or said differently, the number of sub-pixels which contribute to the luminance of the pixel is lower than the number of sub-pixels which have to contribute to obtain the desired color of the pixel. The desired color of the pixel is determined by the image to be displayed. Thus, less sub-pixels are driven if the luminance of the pixel is below a predetermined level. The use of less sub-pixels to generate the same luminance or luminance increases the current density in the sub-pixel used and thus decreases the non-uniformity. Although the correct luminance is obtained, the color of the pixel deviates from the desired color. However, at low luminance, the human eye is less sensitive to the actual color displayed but is still very sensitive to the luminance. It usually is less noticeable if a color error is produced at low luminance. The predetermined level of the luminance below which less sub-pixels are driven than required to obtain the desired color, depends on the image content and the construction of the pixels. In practical implementations of a particular construction of the pixels, this predetermined level is optimally selected between 0.5 and 6% of the maximum luminance. If the color of the pixels of which the luminance is below the predetermined level (further referred to as threshold pixels) is replaced by white light (only the white sub-pixel is driven) the particular level can be selected higher than if only one of the saturated colors (only the red, green, or blue sub-pixel is driven) is used. In the latter case, the predetermined level can be selected higher if the desired color is nearer to one of the saturated colors.

For multi-primary displays the number of optimal required colors to obtain the desired pixel color e.g. white can be higher (e.g. RGBCMY) than the number of minimal required colors e.g. RGB or CMY or only GM etc.

In an embodiment as claimed in claim 2, the pixel comprises three sub-pixels generating light having different colors. Preferably the colors are the primary colors red, green, and blue, respectively. If it is detected that the luminance of the pixel is below the predetermined level, only one or two of the three sub-pixels are driven. The sub-pixels are driven to obtain the correct desired luminance. This will give rise to a deviation from the desired color, if more sub-pixels are required to obtain the desired color. For example, if all three sub-pixels have to be driven to obtain the correct desired luminance and color, if the luminance of the pixel is below the predetermined level, only one or two sub-pixels are driven such that the desired luminance is displayed at the wrong color. Alternatively, if two sub-pixels have to be driven to obtain the correct desired luminance and color, if the luminance of the pixel is below the predetermined level, only one sub-pixel is driven such that the desired luminance is displayed at the wrong color. If only one sub-pixel is to be driven to obtain the correct desired luminance and color, no improvement of the luminance uniformity is possible. Also at a luminance of the pixel below the predetermined level still one sub-color is driven.

In an embodiment as claimed in claim 4, the means for controlling are arranged to control the drive circuit to drive only a single one of the sub-pixels if the desired luminance is below the predetermined level. If only a single sub-pixel is driven, the maximum current is obtained in this sub-pixel, and the luminance uniformity will be improved.

In an embodiment as claimed in claim 5, the number of sub-pixels selected to contribute to the desired luminance gradually decrease dependent on the level of the luminance of the pixel.

In an embodiment as claimed in claim 6, the means for controlling comprises means for determining the sub-pixels to be driven out of the available sub-pixel colors to obtain a color of the at least one pixel nearest to the desired color. For example, the color coordinates of the desired color are determined, and the primary color is selected of which the color coordinates have the smallest difference with the color coordinates of the desired color.

In an embodiment as claimed in claim 7, the pixel comprises sub-pixels of which one generates white light. Preferably, the other sub-pixels generate light being red, green, blue, respectively. In such a matrix display, the extra white pixel allows to boost the luminance level of white.

In an embodiment as claimed in claim 8, the means for controlling are arranged to control the drive circuit to drive only the sub-pixel generating the white light. This provides less noticeable disturbance because the eye sensitivity shifts to black/white for low luminance. At low luminance levels, it is therefore possible to generate white light instead of light which has a primary color.

In an embodiment as claimed in claim 9, the active matrix display further comprises a further pixel including further sub-pixels. The further pixel is arranged adjacent to the first mentioned pixel. The drive circuit is controlled to drive only a subset of the first mentioned sub-pixels and only a subset of the further sub-pixels. If the desired luminance of at least one of the first mentioned pixel or the further pixel is below the predetermined level, the subset of the first mentioned sub-pixels and the subset of the further sub-pixels is selected to obtain a color being substantially an average of the desired color of the first mentioned pixel and a desired color of the further pixel. This approach has the advantage that it is possible to generate the correct color, but at a lower resolution.

In an embodiment as claimed in claim 11, the active matrix display comprises three adjacent pixels. Each one of the three pixels comprises a red, green and blue sub-pixel. If the desired luminance of the pixel or the sub-pixels is below the predetermined level, the controller controls the driver to drive only: the red sub-pixel of the first one of the three pixels, the green sub-pixel of the second one of the three pixels, and the blue sub-pixel of the third one of the three pixels. Again, besides the correct luminance, the desired color can be obtained at a higher current of the driven sub-pixels. The pixels which in combination produce the correct desired color and the correct desired luminance may comprise more than three sub-pixels. This combination of pixels may comprise more than three pixels.

In an embodiment as claimed in claim 13, the pixel comprises a red, green, blue, magenta, yellow, and cyan sub-pixel. The controller controls the driver to only drive a sub-pixel of the pixel if the luminance of this sub-pixel is above an associated predetermined level.

These and other aspects of the invention are apparent from and will be elucidated with reference to the embodiments described hereinafter.

### BRIEF DESCRIPTION OF THE DRAWINGS

In the drawings:

FIG. 1 shows a detailed view of part of the matrix display device,

FIG. 2 shows an embodiment of a pixel driving circuit,

FIG. 3 shows an example to illustrate the non-uniformity of the luminance of a pixel,

FIG. 4 show examples of selecting fewer colors than required to display the desired color to reach the same luminance at a lower non-uniformity,

FIG. 5 shows an example of the effect of selecting fewer colors than required on the non-uniformity,

FIG. 6 shows the color triangle in the color space,

FIG. 7 shows an embodiment of the active matrix display, and

FIG. 8 show embodiments of pixel configurations.

### DETAILED DESCRIPTION OF THE PREFERRED EMBODIMENT

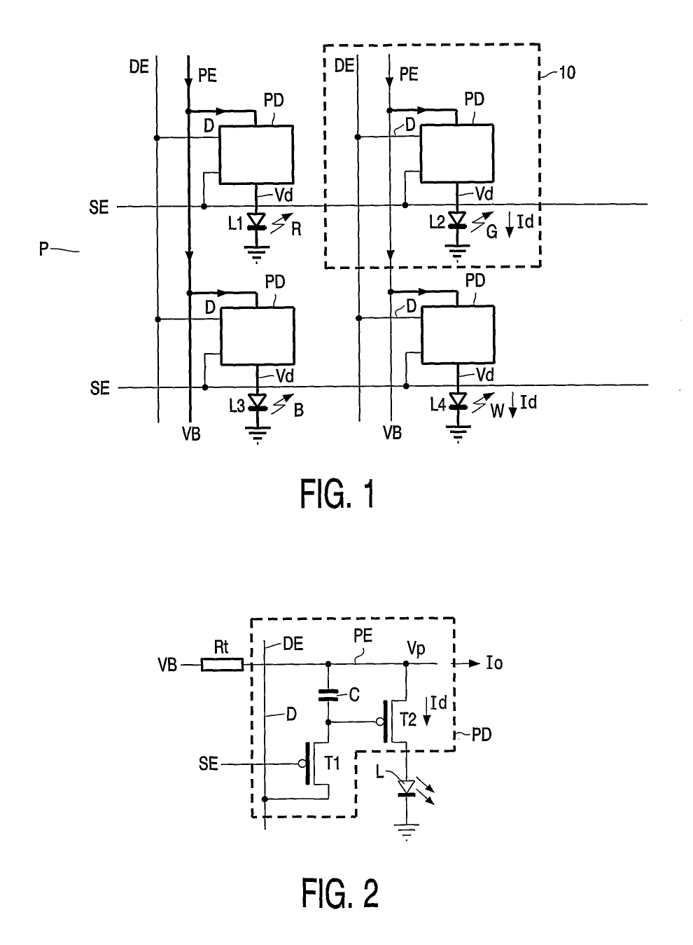

FIG. 1 shows a detailed view of part of the matrix display device. Only one pixel P which comprises four sub-pixels 10 is shown. In a practical implementation, the matrix display device usually has many more pixels P which are arranged in rows and columns. Usually, in a pixel P having four sub-pixels 10, the sub-pixels 10 generate light which has the color red R, green G, blue B, and white W, respectively. Alternatively, the pixel P may also comprises three sub-pixels which generate light with the colors red R, green G, blue B, respectively. In fact, the pixel P may comprise any number of sub-pixels having suitable colors to be able to reproduce the desired colors.

Each sub-pixel 10 comprises a LED L1, L2, L3, L4 (further collectively referred to as L) and a pixel driving circuit PD. The LED's L may be, for example, inorganic electroluminescence (EL) devices, organic EL devices, cold cathodes, or organic LED's like polymer or small molecule LED's. Especially, Polymer and Small Molecule OLED's have opened a new path to make high quality displays. The advantages of these displays are the self-emissive technology, a high luminance, a near-perfect viewing angle and a fast response time. These advantages indicate that the OLED technology holds the promise of providing a better front of screen performance than LCD displays. The different LED's may generate different colors or the LED's may generate, for example, white light and suitable color filters are implemented. In FIG. 1, the LED's L1, L2, L3, L4 generate red R, green G, blue B, and white W light. The luminance of a particular LED L is determined by the current Id flowing through it.

It is possible to use passive matrix and active matrix addressing. For relatively large displays (>7″), which are considered in the now following, active matrix addressing is required to reduce the power consumption.

By way of example, in FIG. 1, the active matrix display comprises select electrodes SE which extend in the row direction and data electrodes DE which extend in the column direction. It is also possible that the select electrodes SE extend in the column direction and that the data electrodes DE extend in the row direction. Again, by way of example, the power supply electrodes PE which supply the current Id to the sub-pixels 10 extend in the column direction. The power supply electrodes PE may as well extend in the row direction, or may form a grid.

Each pixel driving circuit PD receives a select signal from its associated select electrode SE, a data signal D from its associated data electrode DE, a power supply voltage VB from its associated power supply electrode PE, and supplies a voltage Vd and a current Id to its associated LED L. Although for each pixel 10 the same references are used to indicate the same elements, the value of signals, voltages and data may be different.

The current Id is driven through the LED L via the pixel driving circuit PD and the power supply electrode PE. The luminance of the LED is determined by the level of the current Id which is flowing through the LED. The current Id is determined by the data signal level D on the data electrode DE. The select electrodes (also commonly referred to as address lines) SE are used to select (or address) the rows of pixels 10 one by one. In practice, more address lines per display line may be used, for example to control the duty cycle of the current Id supplied to the LED's L. It is possible to select more than one row of pixels 10 at a time.

FIG. 2 shows an embodiment of a pixel driving circuit. The pixel driving circuit PD comprises a series arrangement of a main current path of a transistor T2 and the LED L. The transistor T2 is shown to be a Thin Film Transistor (TFT) but may be another transistor type, the LED L is depicted as a diode but may be another current driven light emitting element. The series arrangement is arranged between the power supply electrode PE and ground (either an absolute ground or a local ground, i.e. common voltage). The control electrode of the transistor T2 is connected to a junction of a capacitor C and a terminal of the main current path of the transistor T1. The other terminal of the main current path of the transistor T1 is connected to the data electrode DE, and the control electrode of the transistor T1 is connected to the select electrode SE. The transistor T1 is shown to be a TFT but may be another transistor type. The still free end of the capacitor C is connected to the power supply electrode PE.

The operation of the circuit is elucidated in the now following. When a row of pixels is selected by an appropriate voltage on the select electrode SE with which this row of pixels is associated, the transistor T1 is conductive. The data signal D which has a level indicating the required luminance of the LED L is fed to the control electrode of the transistor T2. The data signal D defines the gate-to-source voltage, Vgs, of the transistor T2, and thus determines the desired current Id flowing from the power supply electrode PE to the LED L. After the select period of the row of pixels, the voltage on the select electrode SE is changed such that the transistor T1 becomes a high resistance. The data voltage D which is stored on the capacitor C still drives the transistor T2 to obtain the desired current Id through the LED L. The current Id will change when the select electrode SE is selected again and the data voltage D is changed.

The current Id is supplied by the power supply electrode PE which receives the power supply voltage VB via a resistor Rt. The resistor Rt represents the resistance of the power supply electrode towards the pixel 10 shown. It has to be noted that other pixels 10 associated with the same power supply electrode PE may carry current too; this current is denoted by Io. Both the currents Id and Io flow through the resistor Rt and thus cause a voltage drop in the power supply electrode PE. The pixel driving circuit PD will only function correctly if the voltage Vp across the series arrangement of the main current path of the transistor T2 and the LED L is sufficiently high to obtain the current Id. The resistor Rt and its influence is not relevant to the present invention.

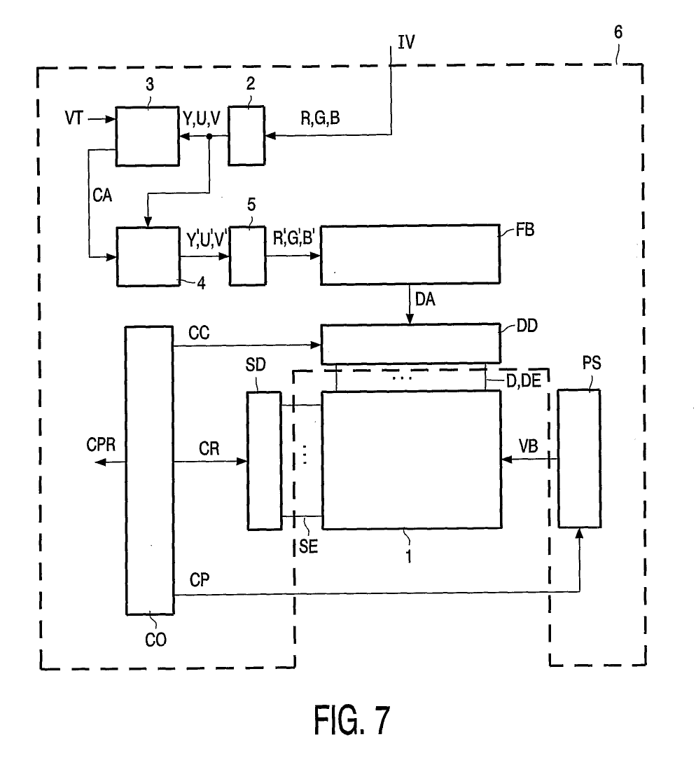

It is commonly known how to drive the sub-pixels 10 of the pixels to display an image on the display 1. In short, an input signal IV (see FIG. 7) representing the image to be displayed is stored in a frame memory FB. From the input signal IV the data D for each one of the sub-pixels 10 of each one of the pixels P is determined to obtain the desired luminance of the sub-pixels P. The desired luminance and the desired color of a particular one of the pixels P is obtained by mixing of the light generated by the associated sub-pixels 10. For example, if the sub-pixels 10 emit red R, green G, and blue B light, all colors within the color triangle CT (see FIG. 6) spanned by the color coordinates of the sub-pixels 10 can be realized by selecting the appropriate luminance ratio of the sub-pixels 10. The luminance of the pixel P is determined by the sum of the luminance of the sub-pixels 10.

The construction of the pixel driving circuits PD is not essential to the invention. For example, some alternative pixel driving circuits PD are disclosed in the publication “A Comparison of Pixel Circuits for Active Matrix Polymer/Organic LED Displays”, D. Fish et al, SID 02 Digest, pages 968-971.

As will be elucidated with respect to the now following Figs., the present invention differs from the known drive of the pixels P in that is determined for each pixel P whether the luminance of a pixel P is below a predetermined threshold. If this is true, less sub-pixels 10 of this pixel P are selected to contribute to the luminance of the pixel P than required to obtain the desired color of this pixel P. Preferably, with the sub-set of sub-pixels 10 driven, still the desired luminance of the pixel P is obtained. Thus, the luminance of at least one of the sub-pixel(s) 10 used to contribute has to increase to still be able to substantially produce the desired luminance. The color of the pixel P will deviate from the desired color. A deviation from the desired color at low luminance levels is less noticeable. However, a deviation from the desired luminance would be more visible. The higher luminance of the sub-pixel(s) 10 used is realized by a higher current Id through the sub-pixel(s) 10 and consequently, as will be elucidated in the following, the non-uniformity of the luminance of the pixels P decreases. Thus, the luminance uniformity is improved at the cost of color deviations, which, however, are not very visible at the low luminance levels involved. It is more important to keep the luminance level substantially equal to the desired luminance.

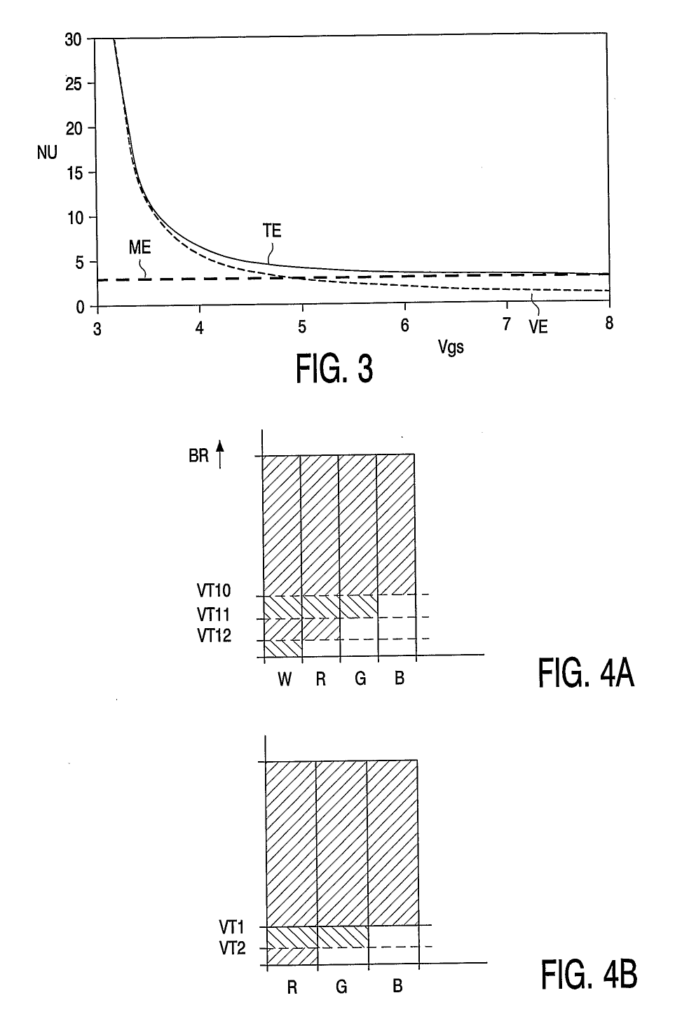

FIG. 3 shows an example to illustrate the non-uniformity of the luminance of a pixel. The vertical axis of the graph shows the non-uniformity NU as a percentage, the horizontal axis of the graph shows the gate-source voltage Vgs of the TFT T2 in volts. The line ME shows the mobility error, the line VE shows the threshold voltage error, and the line TE shows the total error. FIG. 3 shows these errors, by way of example, for small molecule and polymer organic LED's which especially suffer from image non-uniformity at low luminance levels. In FIG. 3, the non-uniformity steeply rises at gate-source voltages Vgs below approximately 3.5 volts. At relatively low gate-source voltages Vgs, the impedance of the FET T2 is relatively high, the current Id through the LED L is relatively low, and thus the luminance of the sub-pixel 10 is relatively low.

Thus, the non-uniformity of the voltage programmed current driven pixels P is caused by variations in the threshold voltage and the mobility of the transistor T2. The usually used Low Temperature Poly-Silicon TFT inherently suffer from point to point variations in their threshold voltage and mobility due to the random variations in the silicon grains formed when annealing. The variations in these parameters cause different currents Id in different sub-pixels 10 at a same given gate-source voltage of the transistors T2.

The current Id of a sub-pixel 10 depends on the TFT mobility μ and the TFT threshold Vt according to equation 1.
Id˜μ(Vgs−Vt)² equation 1
Consequently, the luminance of the sub-pixels show random deviations with respect to each other although the same gate source voltages are applied. These random luminance deviations, or luminance non-uniformities, are visible in the image displayed as random noise. The percentage variation of the current Id through the TFT T2 with respect to its threshold voltage and mobility must be below about 2% to be invisible. FIG. 3 shows, for a uniform image, the standard deviation of the luminance of the sub-pixels 10 divided by the average luminance of the image, expressed as a percentage value. The errors originating from the threshold voltage non-uniformity increase rapidly with decreasing data voltage. Consequently, the luminance of the image will be highly non-uniform at low luminance. At high luminance, the mobility non-uniformity becomes evident.

Several advanced pixel designs were proposed to mitigate these luminance non-uniformities. Among these designs are solutions called digital display, threshold voltage shift display, current mirror display, and on optical feedback circuit, which all add circuitry to compensate for the non-uniformity. In contrast, the present invention may use any drive circuit, also the simple drive circuit shown in FIG. 2. Only the drive of the sub-pixels 10 is adapted in that fewer sub-pixels 10 are driven and thus generate light than required to produce the desired color of the pixel P. The higher current in the sub-pixels 10 driven, decreases the threshold voltage non-uniformity.

FIG. 4 show examples of selecting fewer colors than required to display the desired color to reach substantially the same luminance at a lower non-uniformity. Both FIG. 4A and FIG. 4B show the luminance BR along the vertical axis and the colors of the sub-pixels 10 of the pixel P along the horizontal axis. In FIG. 4A the pixels P comprise four sub-pixels 10 with the colors red R, green G, blue B, white W. In FIG. 4B the pixels P comprise three sub-pixels 10 with the colors R, green G, and blue B. The dashed areas indicate which sub-pixels are contributing to the pixel P luminance and color.

It is known that eyes of human beings are less color sensitive at low luminance levels. From perception investigations we found that, depending on the image content, color errors are acceptable below a luminance level of 0.5 to 6% of the maximum luminance. Thus below this threshold, the pixel color information (the color coordinates in the x-y plane, see FIG. 6) is less relevant. However, as said before, variations in the pixel intensity are still noticeable. In a practical implementation of an active matrix display with poly-LED's with pixels P which have RGBW sub-pixels 10, it has been found that for the darkest 20 to 40 levels of the pixel P, instead of driving the RGB sub-pixels 10, it is possible to only drive the white W sub-pixel 10 to produce the same light intensity. Or said more general, it is possible to use a reduced number of sub-pixels 10 to generate the light of a pixel P if the luminance of this pixel P is below a predetermined threshold. Preferably, if a white sub-pixel 10 is available, the contribution of the RGB sub-pixels 10 is replaced by the white sub-pixel. Alternatively, it is possible to drive a sub-set of the RGB sub-pixels which are required to generate the desired color. For example, if all the three sub-pixels RGB have to contribute to the pixel luminance to obtain the desired color, only two or one of the sub-pixels 10 actually contribute(s) to obtain substantially the same pixel luminance. This will cause a deviation from the desired color. Preferably, the color(s) of the sub-pixel(s) 10 selected to contribute to the pixel luminance are selected to obtain a minimal color deviation.

In the usual, precise, color reproduction mode, all the sub-pixels 10 required to obtain the desired color are driven to contribute to the luminance of the pixel P. In the low-luminance mode, only a subset of these sub-pixels 10 is driven to contribute to the luminance of the pixel P. The number of sub-pixels 10 activated during the low-luminance mode may depend on the luminance of the pixel P. The transition from the precise color reproduction mode to the low-luminance mode can be realized in a single step or, alternatively, in a number of consecutive steps wherein with decreasing luminance fewer sub-pixels 10 contribute to the luminance of the pixel P.

FIG. 4A shows an example of a multi-step transition in a RGBW display. Above the luminance level VT10, all the sub-pixels 10 with the colors red R, green G, blue B, and white W contribute to the luminance of the pixel P to be able to display the correct desired color with the desired luminance. In between the luminance levels VT10 and VT11, only the sub-pixels 10 with the colors red R, green G, and white W contribute to the luminance of the pixel P. Depending on the desired color of the pixel P other sub-pixels 10 than the sub-pixels 10 with the colors red R and green G are driven such that the desired color is approximated best. To produce the same luminance, the luminance of at least one of the sub-pixels 10 with the colors red R, green G or white W is higher after the transition then before the transition. The optimal ratio of the luminance produced by sub-pixels 10 with the colors red R and green G can be determined from the color triangle such that the color coordinates of the realized color are closest to the desired color of the pixel P. In-between the luminance levels VT11 and VT12, only the sub-pixels 10 with the colors red R and white W contribute to the luminance of the pixel P. To produce the same luminance, the luminance of at least one of the sub-pixels 10 with the colors red R or white W is higher after the transition then before the transition. Below the luminance level VT12, only the sub-pixel 10 with the color white W contributes to the luminance of the pixel P. Thus, instead of producing the correct desired color by driving the four sub-pixels 10 with relatively small currents Id, now only one of the sub-pixels 10 is driven with a relatively high current to minimize the non-uniformity. The correct luminance is realized but at the wrong color.

The three luminance level transitions shown in FIG. 4A is an example only. Alternatively, for example, only a single transition may be implemented in which below a predetermined luminance level only the white W sub-pixel 10 or one of the sub-pixels with the primary colors R, G, B contributes to the luminance of the pixel P. Which sub-pixel 10 is selected may depend on the actual color to be displayed. For example, if the actual color is very near to primary red R, only the red sub-pixel 10 is selected to contribute to the luminance of the pixel P. More in general, because the color coordinates of the desired color are known, it is possible to find the nearest color in the color triangle of FIG. 6 which can be displayed by activating only one of the sub-pixels 10.

FIG. 4B shows an example of a multi-step transition in a RGB display. Above the luminance level VT1, all the sub-pixels 10 with the colors red R, green G, and blue B contribute to the luminance of the pixel P to be able to display the correct desired color with the desired luminance. In between the luminance levels VT1 and VT2, only the sub-pixels 10 with the colors red R and green G contribute to the luminance of the pixel P. Preferably, the sub-pixels 10 with the colors appropriate to approximate the desired color best are selected to contribute to the luminance of the pixel P. In the example shown, the red R and green G sub-pixels 10 have to be driven to approximate the desired color best and such that the luminance obtained is substantially equal to the desired luminance. To produce the desired luminance, the luminance of at least one of the sub-pixels 10 with the colors red R or green G is higher after the transition then before the transition. The optimal ratio of the luminance produced by sub-pixels 10 with the colors red R and green G can be determined from the color triangle. This will be elucidated in detail with respect to FIG. 6. Below the luminance level VT2, only the sub-pixel 10 with the color red R contributes to the luminance of the pixel P. Thus, instead of producing the correct desired color by driving the three sub-pixels 10 with relatively small currents Id, now only one of the sub-pixels 10 is driven with a relatively higher current to minimize the non-uniformity. Again, substantially the correct luminance is realized but at the wrong color. Of course only one of the other sub-pixels 10 may be driven if the associated color better approximates the desired color. Many other transitions are possible, for example, only a single transition from three sub-pixels 10 which contribute to the luminance of the pixel P to one sub-pixel 10 which contributes at a luminance level in between the levels VT1 and VT2.

During each frame period of the input signal IV, the transition has to be calculated for each pixel P for which the luminance is below the highest or single threshold level VT1 or VT10. In general, and especially for OLED displays, the aperture of the various sub-pixels 10, and the dimensions of the TFT T2 are optimized with respect to the efficiencies and lifetime of the light emitting materials of the different colors of the sub-pixels 10. The most suitable threshold(s) and transition step strategies can be determined experimentally by looking to the effect reached on the display, taking all these parameters into account.

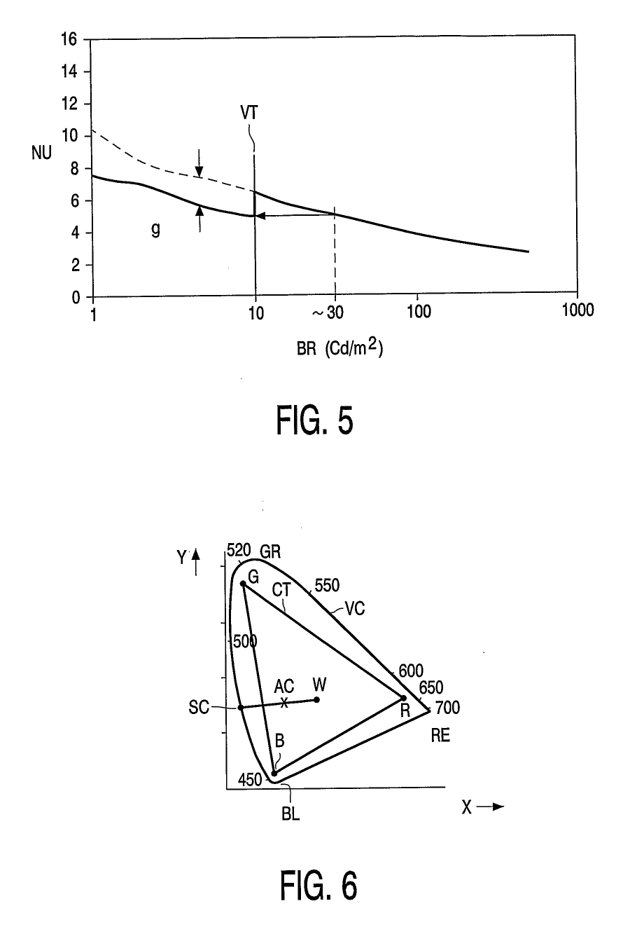

FIG. 5 shows an example of the effect on the non-uniformity of selecting fewer colors than required to obtain the desired color. The vertical axis shows the non-uniformity as a percentage, the horizontal axis shows the luminance BR in Cd/m². In the example shown in FIG. 5, a single threshold level VT is implemented at a luminance of 10 Cd/m². Above this threshold level VT all the sub-pixels 10 of the pixel P are driven to contribute to the luminance of the pixel P. Below this threshold level VT, only one of the sub-pixels 10 is driven to contribute to the luminance of the pixel P while the other sub-pixels 10 do not contribute. To reach substantially the same luminance just below the threshold level VT, the current in the single sub-pixels 10 must be much larger than the currents in each one of the driven sub-pixels 10 just above the threshold level VT. Thus, the gate source voltage Vgs of the single driven sub-pixel 10 is much higher and thus the relative luminance error decreases, see FIG. 3. As a consequence, the image uniformity is improved at low luminance levels below the threshold level VT.

This effect is illustrated in FIG. 5 wherein the non-uniformity NU decreases step-wise at the luminance threshold level of 10 Cd/m² due to using only one instead of all the sub-pixels 10 to generate the desired luminance of the pixel P.

FIG. 6 shows the color triangle in the color space. As is commonly known, in light generating systems such as cathode ray tubes and matrix displays, different colors can be generated by mixing of a limited amount of basic or primary colors. FIG. 6 shows the (xy) color space which is a two-dimensional display of the color space at a fixed luminance or luminance. The locus VC in this (xy) color space is the border line of the area which shows all colors visible by humans. The 100% saturated colors are positioned on this locus VC. The numbers adjacent the locus VC indicate the wavelength in nanometers of the associated color. As can be seen, a wavelength of about 450 nm corresponds to fully saturated blue BL, 520 nm to fully saturated green GR and 700 nm to fully saturated red RE. The unsaturated colors are positioned within the locus VC. It is commercially impractical to use fully saturated colors as the primary colors. In a practical implementation, the primary colors R, G, B are selected as is shown by way of example in FIG. 6. All colors which can be represented by using these primary colors R, G, B are indicated by the triangle CT. All the colors on and inside the triangle can be represented by a display device which uses these primary colors R, G, B.

Every color is completely determined by its x and y color coordinates because these coordinates determine the tint and the saturation of the color. At a particular ratio of the primary colors R, G, B (dependent on the color coordinates of the primary colors R, G, B, this ratio may, for example, in the NTSC standard, be: 30:59:11) white W is obtained. The tint of the color of a point AC in the color triangle CT is found as the junction SC of a line through this point AC and the white point W and the locus VC. The saturation of the color of this point AC is determined by the ratio of the distance between on the one hand the points AC and W and on the other hand between the points AC and SC.

Instead of using the three primary colors R, G, B shown it is possible to use more primaries, for example to obtain a polygon covering a larger area of the locus VC than the triangle CT does. It is also possible to add a primary color white W. In the matrix display discussed, the sub-pixels 10 have the different colors determining the polygon indicating which colors can be displayed.

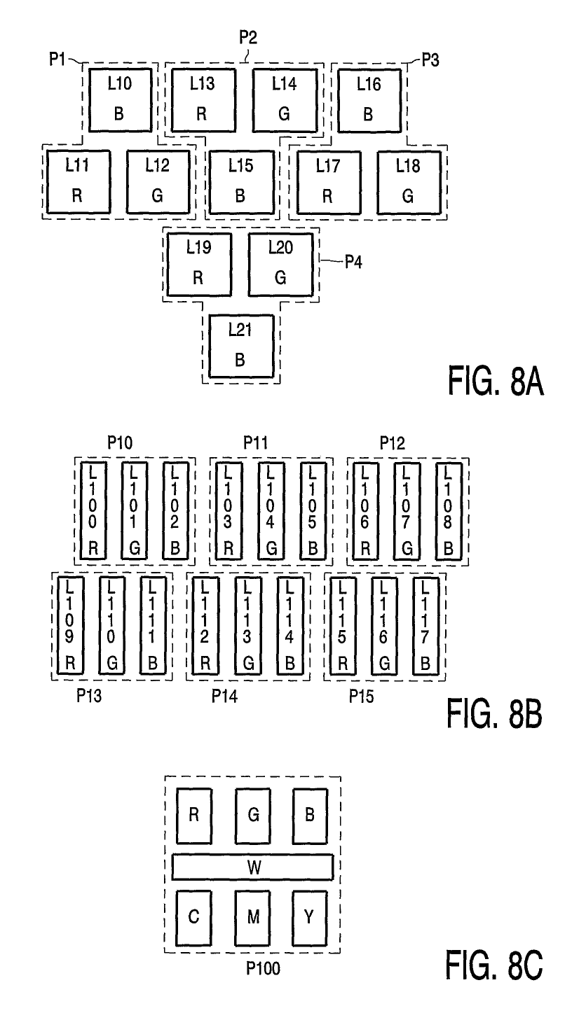

FIG. 7 shows an embodiment of the active matrix display. The active matrix display comprises an active matrix display device 1 which comprises the pixels 10 (see FIGS. 1 and 8) associated with intersecting select electrodes SE and data electrodes DE. The select driver SD supplies select voltages or select data to the select electrodes SE to select the select electrodes SE one by one. This means that the pixels 10 associated with the selected select electrode SE will produce an amount of light determined by the data D supplied by the data driver DD to the data electrodes DE. When a next select electrode SE is selected, the state of the pixels 10 associated with the previously selected select electrode SE is kept. Again the state of the pixels 10 associated with the now selected select electrode SE is determined by the data D on the data electrodes DE. All the select electrodes SE have been selected once after a frame period to display a complete image. The next image will be displayed during the next frame period. The power supply PS supplies the power supply voltage VB to the power supply electrodes PE (see FIG. 1) of display device 1.

FIG. 7 shows an embodiment of the active matrix display with a drive circuit which applies a single luminance threshold VT. The conversion circuit 2 converts the NTSC or PAL R, G, B signals of the input video IV into well known Y, U, V signals. Y is the luminance signal which determines the luminance, and U and V are called the chrominance signals which determine the color. The threshold circuit 3 receives the luminance signal Y and the threshold level VT to detect the pixels P for which the luminance Y is below the threshold level VT. The threshold circuit 3 supplies a control signal CA indicating to the adaptation circuit 4 whether the luminance of the pixel P is below the threshold level VT or not.

The adaptation circuit 4 further receives the Y, U, V signals and supplies the adapted Y′, U′, V′ signals which depend on the received Y, U, V signals and the control signal CA. The adapted Y′ signal is substantially equal to the received Y signal such that the luminance is substantially independent on the number of sub-pixels 10 which contribute to the luminance of the pixel P. If the control signal CA indicates that the luminance Y of the pixel P is below the threshold level VT, the adapted U′, V′ signals are determined from the received U, V signals preferably such that even now less sub-pixels 10 contribute to the luminance of the pixel P, the resultant color is as near as possible to the desired color. For example, the adaptation circuit 4 may comprise a look up table comprising U′ and V′ values for the primary colors R, G and B of the display, and a decision circuit which determines which one of the primary colors R, G, B has U′ and V′ values nearest to the U′ and V′ values of the desired color. For pixels P for which the luminance Y is above the threshold level VT, the adaptation circuit 4 does not adapt the Y, U, V signals received and supplies the adapted Y′, U′, V′ signals which are identical to the Y, U, V signals. The determination of the U′ and V′ values may be performed, for example, with a processor which, for example, calculates gain factors which are used to control the gain of the U and V signals. The adaptation of the level of the Y, U, V signals may then be performed with gain controlled amplifiers. The conversion circuit 5 converts the Y′, U′, V′ signals into R′, G′, B′ signals which are stored in the frame memory FB and which are processed in a know way to be displayed on the display 1.

Alternatively, after correction from the NTSC standard to the color coordinates of the RGB primary colors of the display, the R, G, B signals may be processed directly without converting them to the Y, U, V signals. Usually, the RGB colors of the display differ from the NTSC RGB, i.e. a color correction is required anyhow. The luminance of the R, G, B signals can be calculated as a weighted sum. If the weighted sum is above a threshold level, the R, G, B signals are not adapted. If the weighted sum is below the threshold level, level of the R, G, B signals is adapted such that at least one of the signals gets a zero level while at least one of the others gets an increased level such that the luminance is substantially kept the same. The increased level of the non-zero signal(s) is selected to obtain a color which is nearest to the desired color. The conversion from R, G, B to Y, U, V and the other way around is now not required, but extra calculation power is required to calculate the luminance Y and the color coordinates from the R, G, and B levels. A processor may be used to determine the weighted sum, to detect whether the weighted sum is below the threshold level, to calculate or to find in a look up table adapted levels R′, G′, B′ or correction factors to be applied to the R, G, B signals. Thus, the processor may calculate the adapted levels R′, G′, B′ directly or may calculate the correction factors which are supplied to gain controlled amplifiers. The gain controlled amplifiers receive the R, G, B signals and supply the R′, G′, B′ signals, respectively, dependent on the correction factors.

The controller CO receives the line synchronization signal Hs and the frame synchronization signal Vs of the input video IV to supply a control signal CPR to the input processor, a control signal CR to the select driver SD, a control signal CC to the data driver DD, and a control signal CP to the power supply PS.

The input processor comprises the conversion circuit 2, the threshold circuit 3, the adaptation circuit 4, and the conversion circuit 5. The complete driver circuit 6 comprises the input processor, the frame memory FB, the select driver SD, the data driver DD, the power supply PS and the controller CO. The control signal CPR controls the conversion circuit 2 to retrieve, process and store the R, B, G signals or values of the input signal IV in synchronization with the horizontal synchronization signal Hs and the vertical synchronization signal Vs. The control signals CR, CC and CP synchronize the selection of the rows of pixels 10, the supply of data D to the selected row of pixels 10, and the supply of the power supply voltages VB. The power supply voltages VB may be fixed making the control signal CP superfluous.

It has been found that an acceptable threshold VT depends on the image content and the algorithm used. The acceptable threshold VT varies between 0.5% and 6% of the maximum luminance. When the color of the so-called below threshold pixels P is replaced by white, the threshold value VT can be selected higher than when the color is replaced by red R, green G, or blue B. In the latter case, the threshold VT may be dependent on the saturation of the color of the pixel P: the threshold VT is selected higher at a more saturated color.

FIG. 8 show embodiments of pixel configurations. FIG. 8A shows a pixel configuration of pixels Pi (P1 to P4) which each comprise three square sub-pixels Lj (L10 to L21) which the colors red R, green G, blue B, and which are arranged in a nabla configuration. FIG. 8B shows a pixel configuration of square pixels Pi (P10 to P15) which each comprise three elongated sub-pixels Lj (L110 to L117) with the colors red R, green G, blue B, respectively. FIG. 8C shows a pixel configuration of a square pixels P100 which comprises seven elongated sub-pixels with the colors red R, green G, blue B, cyan C, magenta M, yellow Y, and white W, respectively.

An embodiment in accordance with the invention is directed to the situation wherein a number of neighboring pixels Pi have a luminance below the threshold value VT. This often occurs in dark areas of the image. Now, the average luminance and color of a group of neighboring pixels Pi is determined. For example, such groups comprise three neighboring pixels Pi. The average luminance and color is represented by using of each one of the neighboring pixels Pi of the group only one of sub-pixels Lj. The sub-pixels Lj used have different colors. For example, as shown in FIG. 8A or 8B, if each one of the pixels Pi has a red R, green G, and blue B sub-pixel Lj, and each group of pixels Pi comprises three pixels Pi, only the red R sub-pixel of one of the pixels Pi of the group is used, only the green G sub-pixel of another one of the pixels Pi of the group is used, and only the blue B sub-pixel of the remaining one of the pixels Pi of the group is used. Now, it is possible to produce the correct luminance and the correct color with higher currents in the sub-pixels Lj contributing, but at a lower spatial resolution. However, this seems not to be a problem, because the human eye is less sensitive to spatial details at low luminance levels.

Further improvements in uniformity can be obtained by implementing more complex drive circuits than shown in FIG. 2. For example, a threshold voltage correction circuit acting on the white sub-pixel, while the R, G, B sub-pixels 10 are driven by the standard two transistor circuit of FIG. 2. This provides the same uniformity performance as with an RGB pixel P with threshold compensation for each of the sub-pixels, at a lower component count.

In yet another embodiment in accordance with the invention, a multi-primary display comprises, pixels P100 which comprise seven sub-pixels R, G, B, C, M, Y, W, even a larger freedom exists to select a subset of the sub-pixels 10 at low luminance levels of the pixel P to improve the uniformity. For example, it may be prevented to drive any sub-pixels 10 below the threshold luminance to avoid the non-uniformities to become clearly visible. Thus, the sub-pixels 10 of which the luminance is above the threshold generate light, while the sub-pixels 10 of which the luminance is below the threshold are switched off.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-15. (canceled)

16. An active matrix display (1) comprising
a pixel (P) including sub-pixels (10), and
a drive circuit (6) for receiving an input signal (IV) comprising a desired luminance (BR) and a desired color (AC) of the pixel (P), to drive the sub-pixels (10) of the pixel (P), wherein the image input signal (IV) represents an image to be displayed on the active matrix display (1),
the drive circuit (6) comprising:
a threshold circuit (3) for receiving the image input signal to determine whether the desired luminance (BR) is below a predetermined level (VT), and
an adaptation circuit (4) for, when the desired luminance (BR) is below the predetermined level (VT),
changing a number of the sub-pixels (10) contributing to the desired luminance (BR) into a lower number of sub-pixels (10) than optimally required to obtain the desired color (AC), and
increasing a luminance of at least one sub-pixel (10) of the lower number of sub-pixels (10) to obtain a higher luminance of the at lease one sub-pixel (10) of the lower number of sub-pixels (10) than if all the sub-pixels (10) required to obtain the desired color (AC) would contribute to the desired luminance (BR).

17. An active matrix display as claimed in claim 16, wherein the pixel (P) comprises three sub-pixels (10) generating light having different colors.

18. An active matrix display as claimed in claim 16, wherein the pixel (P) comprises more than 3 sub-pixels (10) generating light having different colors.

19. An active matrix display as claimed in claim 16, wherein the means (4) for changing the number of sub-pixels (10) is arranged for selecting only a single one of the sub-pixels (10) to contribute to the desired luminance (BR) when the desired luminance (BR) is below the predetermined level (VT).

20. An active matrix display as claimed in claim 16, wherein the means (3) for determining whether the desired luminance (BR) is below a predetermined level (VT1) is arranged for further determining whether the desired luminance (BR) is below a further predetermined level (VT2), the means (4) for changing the number of the sub-pixels (10) contributing to the desired luminance (BR) into a lower number than optimally required to obtain the desired color (AC), selecting the lower number below the further predetermined level (VT2) to be lower than below the first mentioned predetermined level (VT1).

21. An active matrix display as claimed in claim 16, wherein the means (4) for changing the number of sub-pixels (10) is arranged for determining the contributing sub-pixels (10) out of the available sub-pixel colors (R, G, B) to obtain a color nearest to the desired color (AC).

22. An active matrix display as claimed in claim 18, wherein one of the sub-pixels (10) is arranged for generating white (W) light.

23. An active matrix display as claimed in claim 22, wherein the means (4) for changing the number of sub-pixels (10) is arranged for selecting only the sub-pixel (10) generating the white light to contribute when the desired luminance (BR) is below the pre-determined level (VT).

24. An active matrix display as claimed in claim 16, further comprising
a further pixel (P) including further sub-pixels (10) and being arranged adjacent to the first mentioned pixel (P),
the means (4) for changing the number of sub-pixels (10) is arranged for driving only a subset of the first mentioned sub-pixels (10) and only a subset of the further sub-pixels (10), the subset of the first mentioned sub-pixels (10) and the subset of the further sub-pixels (10) being selected to obtain a perceived combined color being substantially an average of the desired color (AC) of the first mentioned pixel (10) and a desired color (AC) of the further pixel (10), and to obtain substantially the desired luminance (BR) when the desired luminance (BR) of at least one of the first mentioned pixel (10) or further pixel (10) is below the predetermined level (VT).

25. An active matrix display as claimed in claim 24, wherein the subset of the first mentioned sub-pixels (10) and the subset of the further sub-pixels (10) have different colors.

25. An active matrix display as claimed in claim 24, wherein the active matrix display further comprises a third pixel (P) adjacent to the first mentioned pixel (P), both the first mentioned pixel (P), the further pixel (P), and the third pixel (P) comprises a red (R), green (G) and blue (B) sub-pixel (10), the means (4) for changing the number of sub-pixels (10) being arranged for driving only: the red (R) sub-pixel (10) of the first mentioned at least one pixel (P), the green (G) sub-pixel (10) of the further pixel (P), and the blue (B) sub-pixel (10) of the third pixel (P) when the desired luminance (BR) is below the predetermined level (VT).

27. An active matrix display as claimed in claim 26, wherein the red (R) sub-pixel (10) of the first mentioned at least one pixel (P), the green (G) sub-pixel (10) of the further pixel (P), and the blue (B) sub-pixel (10) of the third pixel (P) are driven to obtain white light.

28. An active matrix display as claimed in claim 16, wherein the pixel (P) comprises a red (R), green (G), blue (B), magenta, yellow, and cyan sub-pixel (10), and wherein the means (4) for changing the number of sub-pixels (10) is arranged for only selecting one of the sub-pixels (10) to contribute if its luminance is above an associated predetermined level (VT).

29. An active matrix display as claimed in claim 16, wherein the matrix display comprises one of: a polymer light emitting display, an organic light emitting display, a liquid crystal display, a plasma display or a field emission display.

30. Method of displaying an image on an active matrix display comprising a pixel (P) including sub-pixels (10), the method comprises receiving (6) an image input signal (IV) comprising a desired luminance (BR) and a desired color (AC) of the pixel (P), the image input signal (IV) representing an image to be displayed on the active matrix display (1),
the method comprising:
determining (3) whether the desired luminance (BR) is below a predetermined level (VT), and when the desired luminance (BR) is below the predetermined level (VT):
changing (4) a number of the sub-pixels (10) contributing to the desired luminance (BR) into a lower number of sub-pixels (10) than optimally required to obtain the desired color (AC), and
increasing (4) a luminance of at least one sub-pixel (10) of the lower number of sub-pixels (10) to obtain a higher luminance of the at least one sub-pixel (10) of the lower number of sub-pixels (10) than if all the sub-pixels (10) required to obtain the desired color (AC) would contribute to the desired luminance (BR).
